(19) United States
(12) Patent Application Publication
(10) Pub. No.: US 2020/0299076 A1
(43) Pub. Date: Sep. 24, 2020

(54) VEHICLE RESTRAINT FOR A LOADING DOCK SYSTEM HAVING LATERALLY OPERABLE RESTRAINT ASSEMBLY

(71) Applicant: Blue Giant Equipment Corporation, Mississauga (CA)

(72) Inventors: ROBERT CAMPBELL YULE, BRAMPTON (CA); GERARD BIASUTTO, WOODBRIDGE (CA); RICHARD LAWRENCE RYMAR, FLUSHING, MI (US); STEVE GRECO, WATERDOWN (CA); MICHAEL JAMES SMALDINO, NORTH COLLINS, NY (US); RICHARD MAX HARWART, BRAMPTON (CA)

(21) Appl. No.: 16/822,127

(22) Filed: Mar. 18, 2020

Related U.S. Application Data
(60) Provisional application No. 62/820,527, filed on Mar. 19, 2019.

(51) Int. Cl. B65G 67/20

(52) U.S. Cl. CPC B65G 67/20

(57) ABSTRACT

A vehicle restraining mechanism for a loading dock system includes a restraint assembly having a barricade member that is rotationally operable between a stored position, a blocking position and a verification position. The barricade member in the blocking position selectively secures a vehicle relative to a wall of a loading dock. A linear actuator laterally operates the barricade member along a linear path of travel that is generally perpendicular to a rotational axis of the barricade member. A sensor is in communication with at least one of the linear actuator and the barricade member. The sensor and the linear actuator cooperate to position the barricade member relative to a rear impact guard of a vehicle that is parked at the loading dock.

### CROSS-REFERENCE TO RELATED APPLICATION

This application claims priority to and the benefit under 35 U.S.C. § 119(e) of U.S. Provisional Patent Application No. 62/820,527 filed on Mar. 19, 2019, entitled VEHICLE RESTRAINT FOR A LOADING DOCK SYSTEM HAVING LATERALLY OPERABLE RESTRAINT ASSEMBLY, the entire disclosure of which is hereby incorporated herein by reference.

### FIELD OF THE INVENTION

The present invention generally relates to barricade restraints for loading docks, and more specifically, a barricade restraint for a loading dock having a linear actuator for adjusting the position of the restraint assembly with respect to the loading dock and various vehicles and trailers parked at the loading dock.

### BACKGROUND OF THE INVENTION

Various loading docks can include barricade restraints that are rotationally operable to a vertical position when a trailer or other vehicle is parked at a loading dock. The vertical position of the barricade restraint maintains the position of the rear impact guard for the vehicle between the barricade restraint and the wall of the loading dock. The barricade restraint is operable to a vertical position to maintain the rear impact guard for the vehicle in this position, until the barricade restraint is lowered to allow for movement of the vehicle away from the loading dock.

### SUMMARY OF THE INVENTION

According to one aspect of the present invention, a vehicle restraining mechanism for a loading dock system includes a restraint assembly having a barricade member that is rotationally operable between a stored position, a blocking position and a verification position. The barricade member in the blocking position selectively secures a vehicle relative to a wall of a loading dock. A linear actuator laterally operates the barricade member along a linear path of travel that is generally perpendicular to a rotational axis of the barricade member. A sensor is in communication with at least one of the linear actuator and the barricade member. The sensor and the linear actuator cooperate to position the barricade member in relation to a rear impact guard of a vehicle that is parked at the loading dock.

According to another aspect of the present invention, a vehicle restraining mechanism for a loading dock system includes a restraint assembly having a barricade member that is rotationally operable at least between a blocking position and a verification position. The barricade member in the blocking position selectively secures a vehicle relative to a loading dock. A linear actuator laterally operates the barricade member along a linear path of travel that is generally perpendicular to a rotational axis of the barricade member. The linear actuator selectively translates the barricade member in the verification position to contact a rear impact guard of a vehicle to define a contact position. Further operation of the linear actuator beyond the contact position biases the barricade member against the rear impact guard and rotates the rear impact guard from the verification position to the blocking position. The restraint assembly includes an operable lock that selectively maintains the barricade restraint in the blocking position.

According to another aspect of the present invention, a method for restraining a vehicle relative to a loading dock system includes parking the vehicle at a loading dock. A barricade member of a restraint assembly is placed in a verification position. The restraint assembly is laterally translated from a retracted position to an extended position relative to the vehicle. The barricade member is engaged in the verification position with a portion of the vehicle. The barricade member is rotated to a blocking position by further laterally translating the restraint assembly to engage a rear surface of a rear impact guard of the vehicle.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a side perspective view of an aspect of the vehicle restraining mechanism, shown restraining a tailgate-type trailer with respect to a loading dock;

FIG. 2 is an enlarged perspective view of the vehicle restraining mechanism of FIG. 1;

FIG. 3 is a cross-sectional view of an aspect of a vehicle restraining mechanism for a loading dock, with the linear actuator shown in a retracted position;

FIG. 4 is a cross-sectional view of the vehicle restraining mechanism of FIG. 3 showing the linear actuator of the vehicle restraining mechanism in an extended position;

FIG. 5 is a cross-sectional view of the vehicle restraining mechanism of FIG. 4 showing the restraint assembly in a fully-extended position;

FIG. 6 is a top plan view of the vehicle restraining mechanism in a retracted position;

FIG. 7 is a side elevational view of the vehicle restraining mechanism of FIG. 6;

FIG. 8 is a rear elevational view of the vehicle restraining mechanism of FIG. 7;

FIG. 9 is a top perspective view of the vehicle restraining mechanism of FIG. 7;

FIG. 10 is a top plan view of an aspect of the vehicle restraining mechanism shown with the linear actuator in an extended position;

FIG. 11 is a side elevational view of the vehicle restraining mechanism of FIG. 10;

FIG. 12 is a top perspective view of the vehicle restraining mechanism of FIG. 11;

FIG. 13 is a top perspective view of an aspect of the vehicle restraining mechanism of FIG. 12;

FIG. 14 is a top perspective view of an aspect of the vehicle restraining mechanism of FIG. 12;

FIG. 15 is a top perspective view of an aspect of the vehicle restraining mechanism of FIG. 12; and

FIG. 16 is a linear flow diagram illustrating a method for restraining a vehicle relative to a loading dock system utilizing an aspect of the vehicle restraining mechanism; and

FIG. 17 is a linear flow diagram illustrating a method for restraining a vehicle relative to a loading dock system utilizing an aspect of the vehicle restraining mechanism.

### DETAILED DESCRIPTION OF THE PREFERRED EMBODIMENTS

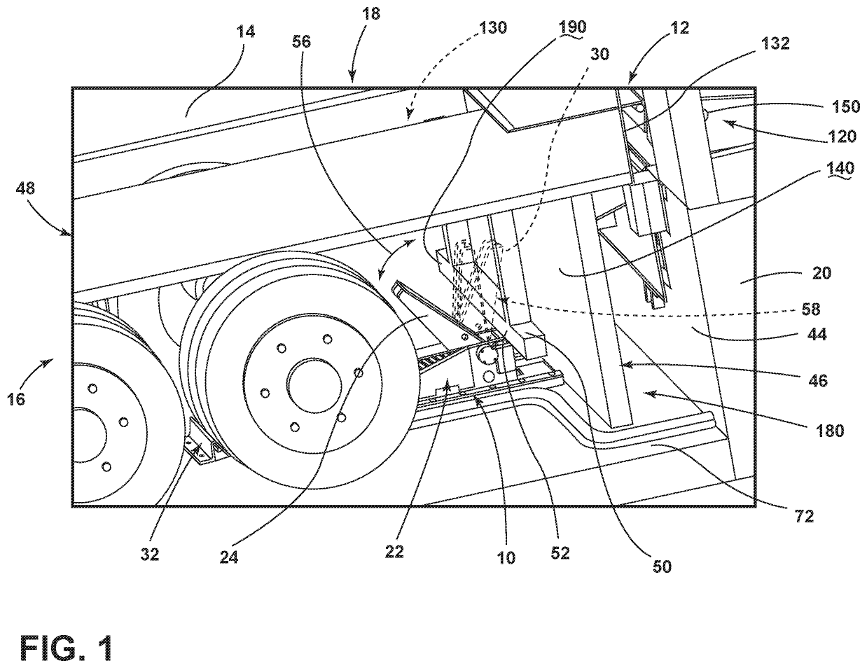

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

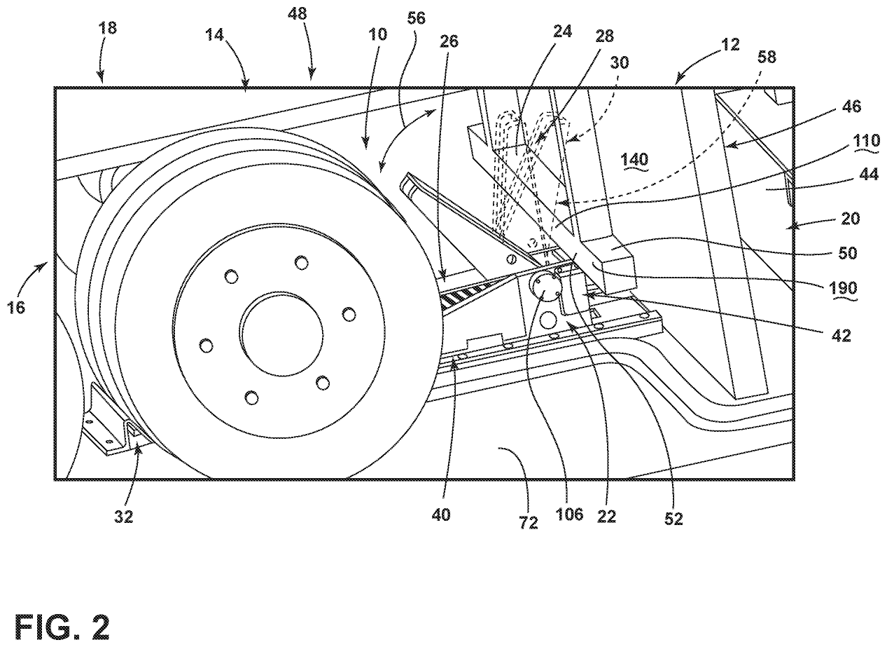

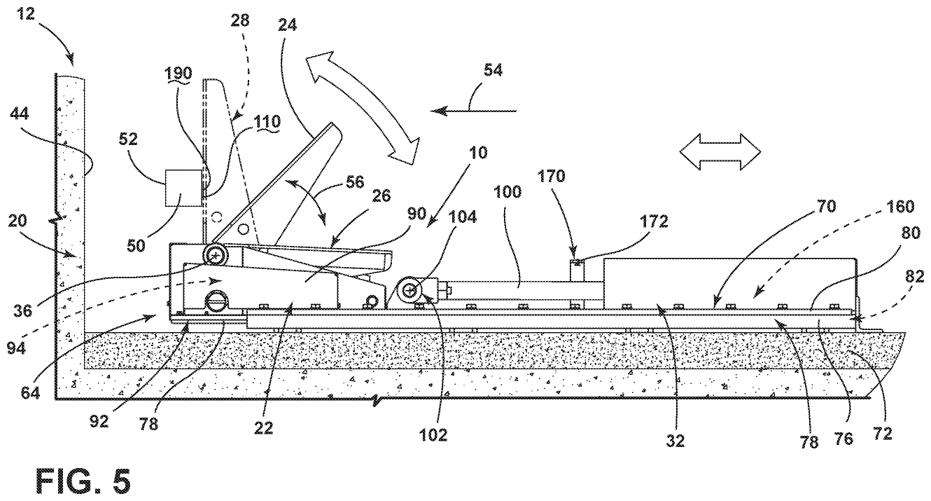

As shown in FIGS. 1-5, reference numeral 10 generally refers to a vehicle restraining mechanism for use in connection with a loading dock 12 for temporarily holding a trailer 14 or other vehicle 16 in a restrained position 18 with respect to a loading dock 12 for a structure 20. According to various aspects of the device, the vehicle restraining mechanism 10 includes a restraint assembly 22 that includes a barricade member 24 that is rotationally operable between a plurality of rotational positions 56, which include a stored position 26, a blocking position 28 and a verification position 30. The barricade member 24 in the blocking position 28 selectively secures a vehicle 16 relative to a loading dock 12. A linear actuator 32 is coupled with the restraint assembly 22 and laterally operates the restraint assembly 22 and the barricade member 24, via an articulating mechanism, along a linear path 34 of travel. This linear path 34 is generally perpendicular to a rotational axis 36 around which the barricade member 24 operates. Accordingly, during operation of the vehicle restraining mechanism 10, the restraint assembly 22 operates along a linear axis 38 through operation of the linear actuator 32. In a particular linear position 40 with respect to the linear actuator 32, the barricade member 24 of the restraint assembly 22 operates about a rotational axis 36. As noted above, this rotational axis 36 is generally perpendicular to the linear axis 38 along which the linear actuator 32 operates. At least one sensor 42 is in communication with one of the barricade member 24 and the linear actuator 32, or both. The one or more sensors 42, the barricade member 24 and the linear actuator 32 cooperate to position the barricade member 24 a predetermined distance from a particular object. This particular object, such as a reference object 52, can be in the form of a wall 44 of the loading dock 12, a lift gate 46 of a lift-gate type vehicle 48 that may be parked at the loading dock 12, a rear impact guard 50, or other similar reference object 52 related to the loading dock 12 and/or the vehicle 16 parked at the loading dock 12. Typically, the reference object is in the form of the rear impact guard 50.

Typically, at least one of the sensors 42 is in communication with each of the barricade member 24 and the linear actuator 32. The sensor 42 can monitor the rotational position 56 of the barricade member 24 during operation of the linear actuator 32. In such an embodiment, selective operation of the linear actuator 32 moves the barricade member 24, while in the verification position 30, into contact with the rear impact guard 50 to define a contact position 58. This contact position 58 can be part of a verification step to verify that the rear impact guard 50 is in an appropriate position to be secured by the barricade member 24 and the linear actuator 32. Once in the contact position 58, the linear actuator 32 operates to translate the restraint assembly 22, in a manner that biases the barricade member 24 against the rear impact guard 50. Using the lateral translation of the linear actuator 32, the barricade member 24 is rotated from the verification position 30 to the blocking position 28. Once in the blocking position 28, the restraint assembly 22 locks the barricade member 24 in the blocking position 28. In certain aspects of the device, a locking mechanism 112 for the barricade member 24 can be engaged before the barricade member 24 reaches the blocking position 28. By way of example, and not limitation, the locking member 112 can be engaged while the barricade member 24 is in the verification position 30 or while the barricade member 24 is moving from the verification position 30 to the blocking position 28.

In certain aspects of the device, at least one of the sensors 42 can be used to monitor, recognize, or otherwise detect, the presence of various obstructions or reference objects 52 that may be located between the wall 44 of the loading dock 12 and the restraint assembly 22. The sensor 42 can be located on one of the linear actuator 32, the restraint assembly 22, or other portion of the vehicle restraining mechanism 10. The sensor 42 can also be located on a portion of the loading dock 12 or other part of the structure 20.

By determining the presence and location of such reference objects 52, the location of the rear impact guard 50 for the vehicle 16 can be assessed and determined through operation of the linear actuator 32 and the barricade member 24, as monitored by the sensor 42. Once the location of the rear impact guard 50 is determined, the linear actuator 32 can operate the restraint assembly 22 to properly position the barricade member 24 to restrain the vehicle 16 in the appropriate restrained position 18 relative to the loading dock 12.

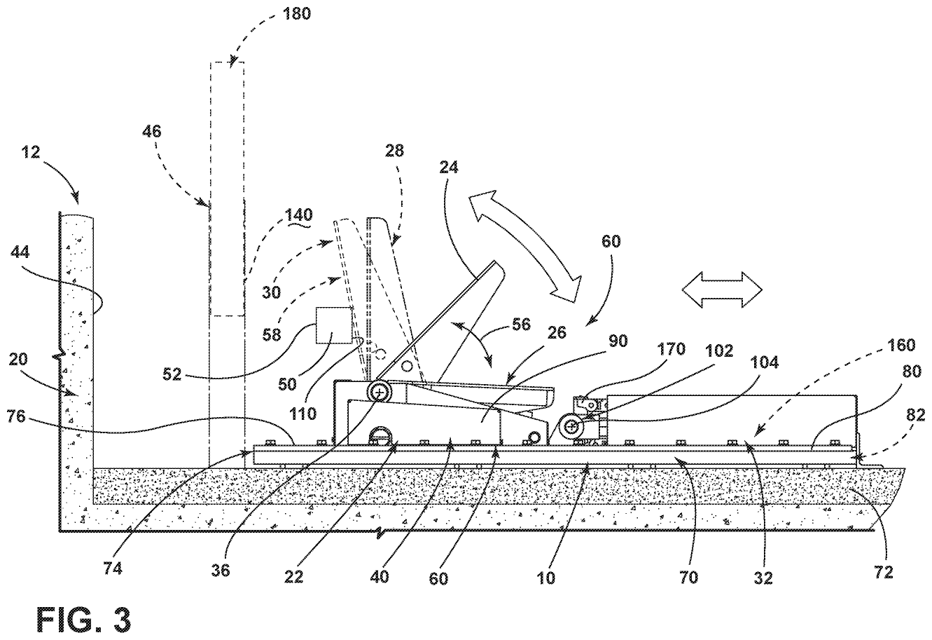

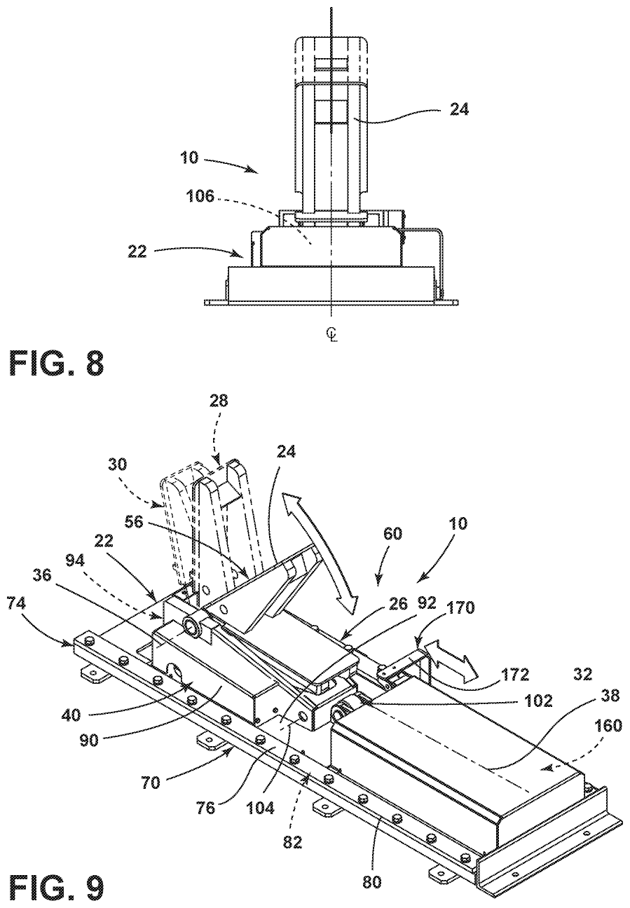

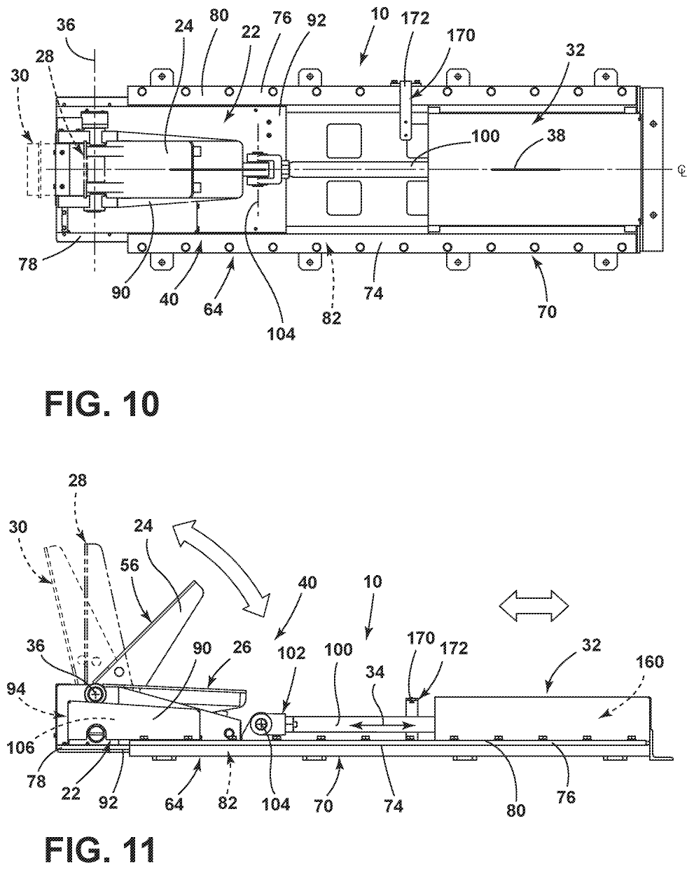

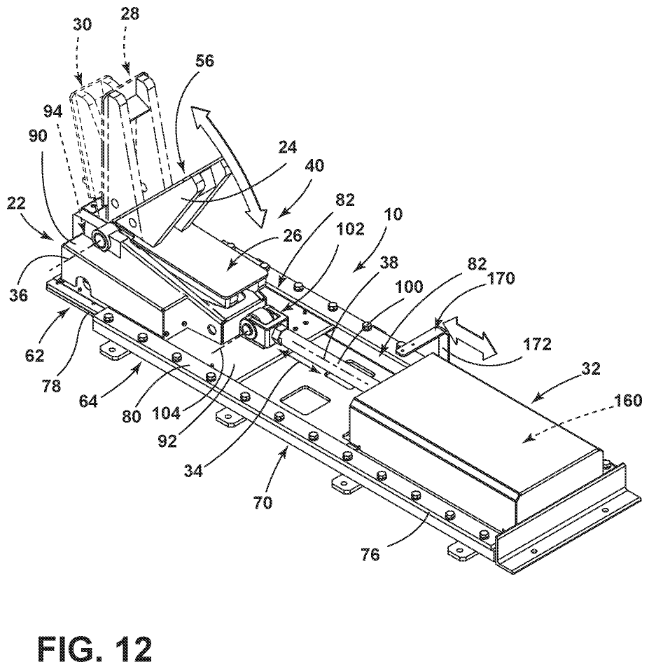

As exemplified in FIGS. 3-12, the linear actuator 32 operates to move the restraint assembly 22 between a plurality of linear positions 40 with respect to the loading dock 12. These positions can include a retracted position 60 and a plurality of extended positions 62. The plurality of extended positions 62 can include a fully-extended position 64 that is indicative of the linear actuator 32 fully extending the restraint assembly 22 toward the wall 44 for the loading dock 12.

Referring again to FIGS. 3-12, the vehicle restraining mechanism 10 can include a track system 70 that fixedly secures the linear actuator 32 to a substrate 72. Typically, this substrate 72 will be in the form of a parking surface that may be covered with concrete, asphalt or other similar material. The use of the track system 70 also operably secures the restraint assembly 22 relative to the substrate 72. By securing the restraint assembly 22 within the track system 70, the restraint assembly 22 is able to laterally translate along the linear axis 38 and between the plurality of linear positions 40 for securing a rear impact guard 50 for a vehicle 16 relative to a wall 44 for the loading dock 12. The track system 70 can include at least one guide member 74 that guides the restraint assembly 22 between the plurality of linear positions 40. Again, these plurality of linear positions 40 can include a retracted position 60 and a plurality of extended positions 62.

According to various aspects of the device, the at least one guide member 74 of the track system 70 can include outer guide rails 76 that engage outer flanges 78 of the restraint assembly 22. These outer guide rails 76 can include one or more retaining members 80 that form a sliding channel 82 through which the outer flanges 78 of the restraint assembly 22 can operate between the plurality of linear positions 40. Additionally, the engagement between the outer flanges 78 for the restraint assembly 22 and the outer guide rails 76 of the track system 70 serves to prevent uplift, twisting, or other deflection within the restraint assembly 22 that may occur through the engagement of the barricade member 24 with a portion of the vehicle 16 operating near the loading dock 12.

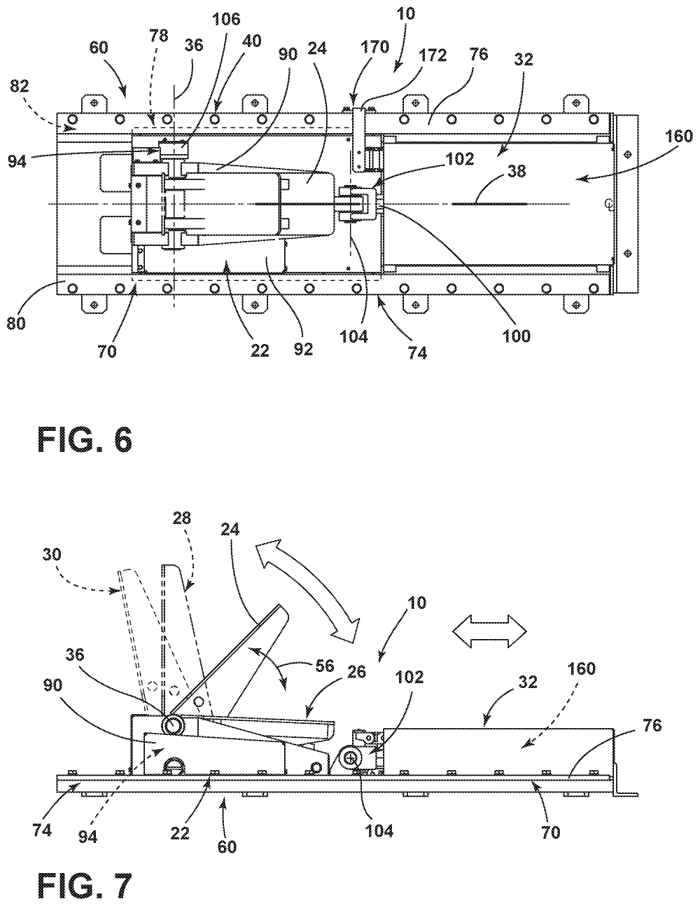

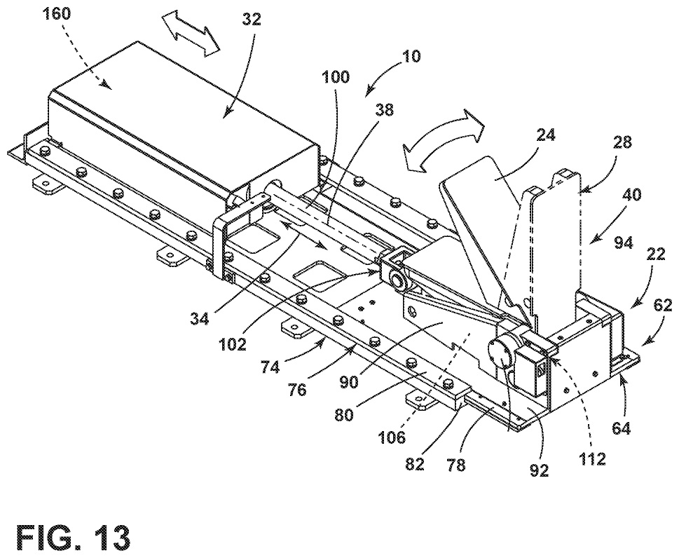

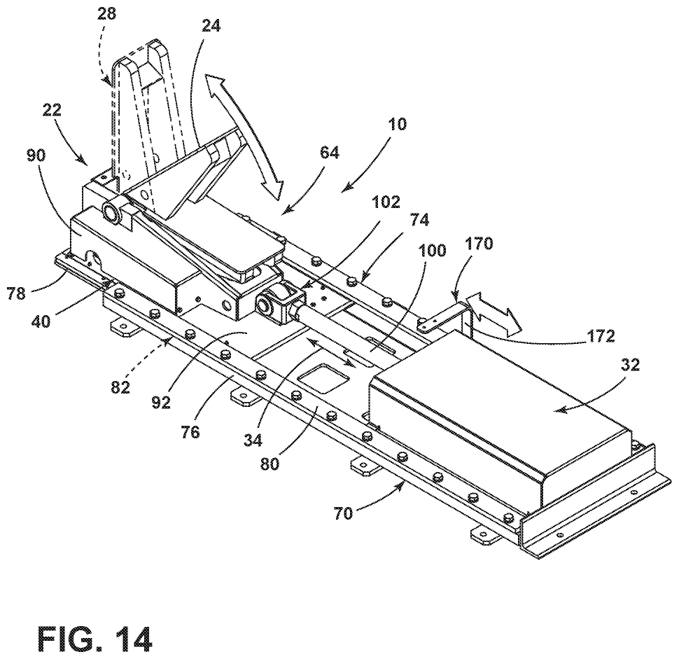

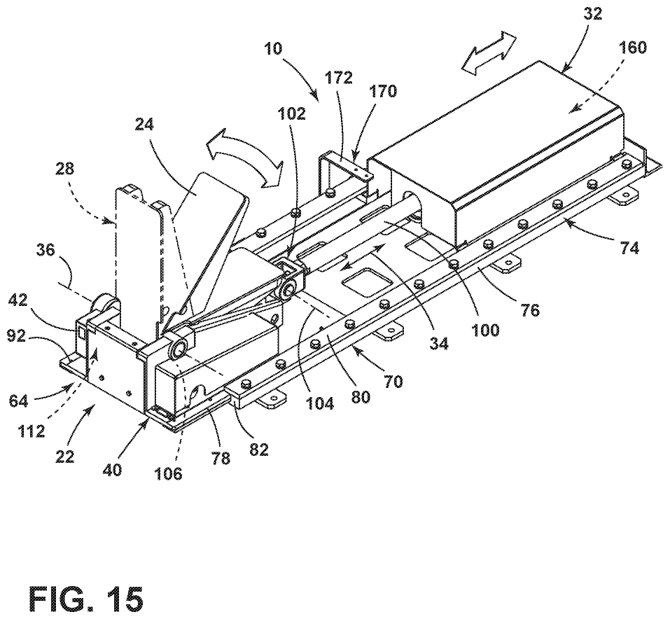

As exemplified in FIGS. 6-15, the restraint assembly 22 can include an outer housing 90 and a structural base 92 that surrounds the operating mechanism 94 for the barricade member 24. The structural base 92 can include the outer flanges 78 that operate within the outer guide rails 76 for the track system 70. The structural base 92 can be in the form of a plate member that slidably operates through the outer guide rails 76 for the track system 70. As discussed above, this structural base 92 and the structural retaining members 80 of the outer guide rails 76 cooperate to prevent movement of the restraint assembly 22 other than the linear operation between the plurality of linear positions 40 that are defined through operation of the linear actuator 32.

By way of example, and not limitation, the structural support provided through engagement of the structural base 92 and the outer guide rails 76 is typically sufficient enough to maintain the position of the restraint assembly 22 under a variety of stress conditions. These stress conditions can include, but are not limited to, attempted movement of the vehicle 16 away from a loading dock 12 when the barricade member 24 is in a blocking position 28 and holding the vehicle 16 in the restrained position 18 relative to the loading dock 12. The engagement of the structural base 92 and the outer guide rails 76 is typically sufficient to maintain the position of the restraint assembly 22. This engagement between the structural base 92 and the outer guide rails 76 is also typically sufficient to withstand impacts and collisions with various vehicles 16 that may be present within a loading dock area.

Referring again to FIGS. 3-15, the linear actuator 32 includes an articulating member 100 that is linearly operable to define the retracted position 60 and the plurality of extended positions 62. The articulating member 100 is typically attached to the restraint assembly 22 at a pivot joint 102 that is oriented generally parallel with the rotational axis 36 of the barricade member 24. By including the pivot joint 102 at the engagement between the linear actuator 32 and the restraint assembly 22, fluctuations of the material of the vehicle restraining mechanism 10 that may occur over time, such as with temperature fluctuations, allow for convenient operation of the restraint assembly 22 by the linear actuator 32.

In typical conditions, the substrate 72 surrounding a loading dock area may not be level or flat and various curves, cracks and undulations are typically present within the substrate 72 surrounding the loading dock 12. By engaging the linear actuator 32 with the restraint assembly 22 through the pivot joint 102, the restraint assembly 22 can operate over the substrate 72 and the connection at the pivot joint 102 can account for these undulations and surface fluctuations within the substrate 72. Accordingly, the vehicle restraining mechanism 10 can be installed and can operate under a wide variety of surface conditions and configurations of the substrate 72. Typically, the pivot joint 102 that engages the linear actuator 32 with the restraint assembly 22 is oriented to have a rotational axis 36 that is generally parallel with the rotational pivot axis 104 of the barricade member 24.

According to various aspects of the device, the connection between the restraint assembly 22 and the linear actuator 32 may include various connection mechanisms. The engagement between the linear actuator 32 and the restraint assembly 22 may be a fixed connection. This attachment between the linear actuator 32 and the restraint assembly 22 may also include a universal joint that allows for a wide variety of movements of the structural base 92 as it moves through the track system 70. As discussed above, the track system 70 is typically placed on a substrate 72 that may not be level or flat and may contain various undulations. These undulations may result in the track system 70 defining various slopes and twisting movements during operation of the restraint assembly 22 through the track system 70 for the vehicle restraining mechanism 10.

Referring again to FIGS. 3-5, the track system 70 for the vehicle restraining mechanism 10 can be anchored directly to the substrate 72, such as through piles or lag screws that are set within concrete poured within the substrate 72. The track system 70 may also be attached to dedicated structural fasteners that are set within the substrate 72. These structural fasteners can be located for receiving the track system 70 and attaching the track system 70 to the substrate 72. The attachment of the track system 70 with these fasteners can be in the form of a bolt or other fastener-type connections, welds, combinations thereof, and other similar fixed attached mechanisms and methods.

As exemplified in FIGS. 3-15, the structural base 92 for the restraint assembly 22 can operate through the track system 70 in a sliding manner. This sliding engagement between the base structure 20 and the track system 70 can be in the form of a sliding engagement, rollers, tracks, bearings, lubricants, combinations thereof and other similar sliding or rolling-type engagements.

During operation of the vehicle restraining mechanism 10, the restraint assembly 22 can be maintained in the retracted position 60 when not in use. The articulating member 100 for the linear actuator 32 is typically attached to the structural base 92 via the pivot joint 102 or other similar attaching mechanisms. The sensor 42 for the vehicle restraining mechanism 10 may be continually active, or may be activated under particular use conditions, such as when a vehicle 16 is to be parked at the loading dock 12. When activated, it is typical that a vehicle 16 is parked or is in the process of being parked at the loading dock 12. Once the vehicle 16 is in a parked position at the loading dock 12, one or more sensors 42 may assess various conditions surrounding the loading dock 12 and the vehicle 16 to determine the positioning of one or more reference objects 52 such as components of the vehicle 16, relative to the loading dock 12. Through these positional determinations, with respect to the reference object or objects 52, the sensor 42 can be used in certain aspects of the device to assess the approximate location of a rear impact guard 50 for a vehicle 16.

As discussed herein, the one or more sensors 42 can also be used to monitor the rotational position 56 of the barricade member 24. In such an embodiment, the barricade member 24 is moved into the verification position 30. The verification position 30 is located rotationally beyond the blocking position 28. The blocking position 28, which is a generally vertical orientation, is between the stored position 26 and the verification position 30. Typically, an actuator 106, such as a hydraulic cylinder of the barricade member 24, is disengaged when the barricade member 24 is in the verification position 30. Accordingly, the barricade member 24 is biased into the verification position 30, typically by the force of gravity. Through this configuration, the linear actuator 32 at least partially operates the barricade member 24. In this manner, the linear actuator 32 operates the restraint assembly 22 during the verification step, the barricade member 24 is in the verification position 30. When the barricade member 24 engages the rear impact guard 50, the linear actuator 32 biases the barricade member 24 against the rear impact guard 50 and causes a rotation of the barricade member 24 from the verification position 30 to the blocking position 28. In certain aspects of the device, the barricade member 24 can engage a different portion of the vehicle 16, such as a lift gate 46 of a trailer 14 or vehicle 16. Typically, the barricade member 24 is configured to engage the rear impact guard 50. It should be understood that the actuator 106 can be in the form of various actuating mechanisms. Such actuating mechanisms can include, but are not limited to hydraulic mechanisms, pneumatic mechanisms, electrical mechanisms, motors, combinations thereof and other similar mechanisms.

Where the barricade member 24 reaches the fully-extended position 64 or engages a wall 44 of the loading dock 12, the verification step results in a non-verification, as no portion of the vehicle 16 or trailer 14 was engaged by the barricade member 24. Where non-verification is determined by engaging a wall 44, the location of the wall 44 of the loading dock 12 can be a predetermined distance that is programmed into the restraining mechanism 10. Where a non-verification occurs, the restraining process of the restraining mechanism 10 repeats or an instruction to realign the vehicle 16 or trailer 14 is given.

To determine the location of the rear impact guard 50, the linear actuator 32 can operate to move the position of the restraint assembly 22 to one of the extended positions 62. When in the proper extended position 62, the barricade member 24 is typically operated via operation of the linear actuator 32 from the verification position 30 to the blocking position 28. In this blocking position 28, the barricade member 24 is typically in engagement with a surface of the vehicle 16, such as a vehicle-forward surface 110 of the rear impact guard 50. Through this engagement, the barricade member 24 and linear actuator 32 for the restraint assembly 22 can hold the vehicle 16 in a particular restrained position 18 with respect to the loading dock 12.

In certain aspects of the device, the barricade member 24 can operate through a range of verification steps to further assess the positioning of the rear impact guard 50 with respect to the loading dock 12. In an exemplary verification step, the barricade member 24 can operate about the rotational axis 36 toward a verification position 30 and will typically directly engage the rear impact guard 50 to define a contact position 58. Where the barricade member 24 does not engage the rear impact guard 50, a control 120 for the vehicle restraining mechanism 10 can communicate with the linear actuator 32 to assess whether the restraint assembly 22 should be repositioned to the retracted position 60 or another of the plurality of extended positions 62. When repositioned, the barricade member 24 may undergo another verification step to again determine where the rear impact guard 50 is located with respect to the loading dock 12. As discussed herein, operation of the linear actuator 32 is utilized to laterally position the barricade member 24 in the blocking position 28 and to at least partially secure the vehicle 16 or trailer 14 relative to the loading dock 12.

According to various aspects of the device, as exemplified in FIGS. 3-5, the rear impact guard 50 can be located in different positions with respect to various vehicles 16. Certain vehicles 16, such as box trucks or other lift-gate type vehicles 48 can include a lift gate 46 at the rear of the vehicle 16 for raising and lowering cargo that may be moved with respect to the storage compartment 130 of the vehicle 16. This lift gate 46 is typically positioned behind the rear impact guard 50. Accordingly, the rear impact guard 50 may not be positioned at the back 132 of the vehicle 16, but can be offset in a vehicle-forward direction from the back 132 of the vehicle 16. By using the vehicle restraining mechanism 10, the linear actuator 32 can properly position the restraint assembly 22 to account for this different position of the rear impact guard 50 relative to the back 132 of the vehicle 16. Accordingly, separate barricade members 24 or restraint assemblies are not necessary relative to a loading dock 12.

The use of the linear actuator 32 in connection with the sensor 42 and the restraining assembly can properly position the barricade member 24 to account for vehicles 16 having rear impact guards 50 that are located in different positions with respect to a back 132 of the vehicle 16. Other types of vehicles 16 such as pup trailers and standard trailers may have rear impact guards 50 that are also positioned at different locations with respect to a back 132 of the vehicle 16. Again, using the linear actuator 32 in connection with the sensor 42 and the restraint assembly 22, the sensor 42 can determine, directly or indirectly, the approximate position of the rear impact guard 50 for a particular type of vehicle 16 that is parked at the loading dock 12. Through the use of the sensor 42, the linear actuator 32 and the restraint assembly 22, the barricade member 24 can be properly positioned to engage the rear impact guard 50 to secure the vehicle 16 in a restrained position 18 with respect to the loading dock 12.

According to various aspects of the device, the sensor 42 for the vehicle restraining mechanism 10 can be used to monitor a position of various reference objects 52 that may be positioned between a wall 44 of the loading dock 12 and a portion of the vehicle restraining mechanism 10. By way of example, and not limitation, in the case of a lift-gate type vehicle 48, the lift gate 46 may generally define a vertical or generally vertical surface 140 at or near the back 132 of the vehicle 16, when the lift gate 46 is not in use. The sensor 42 can monitor or determine the position of this generally vertical surface 140 and can determine the location of the rear impact guard 50, based at least partially upon known standards for the positioning of rear impact guards 50 for various types of vehicles 16. The exact positioning of the rear impact guard 50 may vary based upon manufacturing tolerances, damage to a rear impact guard 50, wear and tear of a rear impact guard 50, and other environmental considerations. The use of the sensor 42 for determining a type of vehicle 16 that is located at the loading dock 12 can provide at least a range within which the restraint assembly 22 should be located through operation of the linear actuator 32. Once in a particular position or range of positions, the barricade member 24 of the restraint assembly 22 can undergo the verification step to determine the exact position of the rear impact guard 50 with respect to the wall 44 of the loading dock 12.

The one or more sensors 42 that are used to determine the location of the rear impact guard 50 or other reference object 52 can include a range of sensor types and sensor functions. Typically, the sensor 42 is positioned in communication with the barricade member 24. As discussed above, lateral translation of the restraint assembly 22 through operation of the linear actuator 32 can cause a rotation of the barricade member 24 as it is biased against the rear impact guard 50. In such an embodiment, the sensor 42 can be used to monitor the rotation and/or rotational position 56 of the barricade member 24 as it is biased from the verification position 30 to the blocking position 28. In certain aspects, the sensors 42 may also be used to sense the location, size and position of a particular reference object 52 or series of reference objects 52 related to a trailer 14 or vehicle 16.

According to various aspects of the device, the sensor 42 may be used to locate the position of the rear impact guard 50 with respect to the wall 44 of the loading dock 12. In such an embodiment, the linear actuator 32 may be operated to move the restraint assembly 22 directly into or close to the linear position 40 needed for allowing the barricade member 24 to engage the rear impact guard 50 in the verification position 30 and, ultimately, the blocking position 28. Typically, the verification step will occur in each situation to provide a back-up system for locating the rear impact guard 50.

After the verification step is complete and the barricade member 24 is moved from the verification position 30 and into the blocking position 28, the barricade member 24 is locked in this blocking position 28 through a locking mechanism 112 of the restraint assembly 22, such as a mechanically or electrically operable lock. This locking mechanism 112 can be engaged any time after the barricade member 24 is rotated past the blocking position 28 and toward the verification position 30. This prevents inadvertent rotation of the barricade member 24 back to the stored position 26.

In certain aspects of the device, the linear actuator 32 can be operated to move the locked barricade member 24, while in the blocking position 28, in the direction of the rear impact guard 50. This operation of the linear actuator 32 may be utilized to apply a predetermined amount of restraining force 54 against the rear impact guard 50. Typically, this restraining force is minimal in magnitude. This restraining force 54 is indicative of the restrained position 18 that holds the vehicle 16 in place with respect to the loading dock 12. When a restraining force 54 against the rear impact guard 50 is achieved, at least one of the sensors 42 of the restraining mechanism 10 senses this predetermined restraining force 54 and stops additional movement of the linear actuator 32. The linear actuator 32 can be held in place by a mechanical locking mechanism 112 that secures the linear actuator 32 in a particular linear position 40 that maintains the position of the barricade member 24 against the rear impact guard 50. The linear position 40 of the linear actuator 32 can also be maintained by the translating mechanism 160, or by a mechanical lock that secures the translating mechanism 160 in the desired linear position 40.

As discussed above, the sensor 42 may be activated only when needed for assisting in the parking of a vehicle 16 relative to the loading dock 12. In various aspects of the device, the sensor 42 may be activated by a manual or automatic start switch 150 that is activated when a vehicle 16 is in a particular location with respect to the loading dock 12. In certain embodiments, a user may manually activate the start switch 150 to initiate a parking process. This parking process may include activating the sensor 42 for locating the reference object 52, such as various portions of the vehicle 16, to determine the type of vehicle 16 and also for locating the position of the rear impact guard 50 with respect to the wall 44 for the loading dock 12.

Referring again to FIGS. 3-15, the articulating member 100 for the linear actuator 32 can be operated through various translating mechanisms 160. These translating mechanisms 160 can be in the form of operable pistons, screw-drive mechanisms, hydraulic mechanisms, pneumatic mechanisms, chain-drive mechanisms, rack-and-pinion mechanisms, and other various motorized assemblies for linearly operating the articulating member 100 for the linear actuator 32.

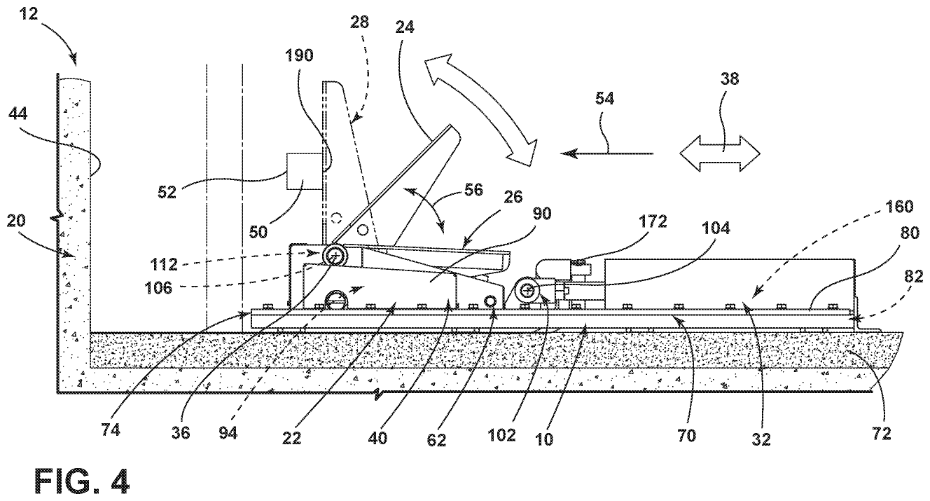

As exemplified in FIGS. 3 and 4, the linear actuator 32 can include various switching mechanisms 170 that can be activated or deactivated when the restraint assembly 22 is moved into the retracted position 60. This switching mechanism 170 can be activated and deactivated by an activation arm 172 that is positioned relative to the linear actuator 32 to engage the switching mechanism 170 when the restraint assembly 22 is moved into the retracted position 60.

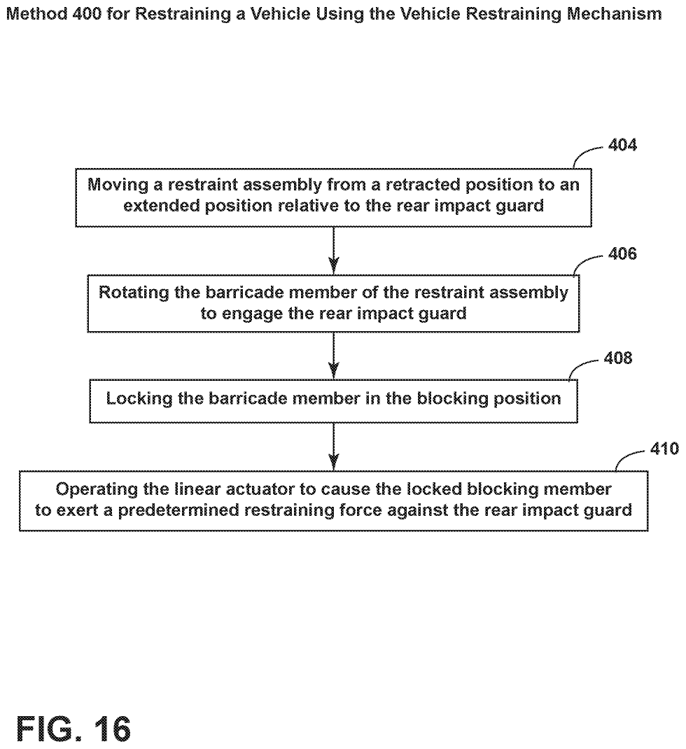

Referring now to FIGS. 1-16, having described various aspects of the vehicle restraining mechanism 10, a method 400 is disclosed for restraining a vehicle 16 relative to a loading dock system utilizing various aspects of the vehicle restraining mechanism 10. According to the method 400, verification process is used to determine a location of a rear impact guard 50 for a vehicle 16 relative to at least one of a back 132 of the vehicle 16 and a wall 44 for the loading dock 12. As discussed above, the location of the rear impact guard 50 can be determined by the sensor 42 directly. In such an embodiment, the sensor 42 can be used to determine a position of the rear impact guard 50 through various sensors that can include, but are not limited to, proximity sensors, motion sensors, position-detecting sensors, and other similar sensors. The verification process can also be accomplished by the sensor 42 determining a type of vehicle 16 that is being parked at the loading dock 12. In such an embodiment, the sensor 42 assesses various positions of certain surfaces or reference objects 52 on the vehicle 16. As with the lift-gate type vehicle 48, the sensor 42 can determine presence of a substantially vertical surface 140 between the wall 44 of the loading dock 12 and the vehicle restraining mechanism 10. This substantially vertical surface 140 is typically the lift gate 46 for the vehicle 16 in a travel position 180. Other vehicles 16 may have various indicating features or reference objects 52 to determine the type of vehicle 16 that is parked at the loading dock 12. As discussed above, various vehicles 16 can have a rear impact guard 50 that can be positioned in various locations with respect to a back 132 of the vehicle 16. The location of the reference object 52, such as the rear impact guard 50, can also be determined by moving the barricade member 24, while in the verification position 30, into contact with the rear impact guard 50 to define the contact position 58. As discussed above, the translation of the barricade member 24 can be accomplished by translating the restraint assembly 22 using the linear actuator 32.

Referring again to FIGS. 1-16, according to the method 400, a step 404 includes moving a restraint assembly 22 from a retracted position 60 to an extended position 62 relative to the rear impact guard 50. As discussed above, the sensor 42 can directly or indirectly determine an approximate position of the rear impact guard 50. This sensing operation can be used to directly determine the location of the rear impact guard 50 or can be indirectly used to first determine a type of vehicle 16 that is located at the loading dock 12 and then determining where the rear impact guard 50 is for that particular type of vehicle 16. According to the method 400, a step 406 includes rotating the barricade member 24 of the restraint assembly 22 to engage the rear surface 190 of the rear impact guard 50 of the vehicle 16 in the blocking position 28. The barricade member 24 can then be locked with respect to the rear impact guard 50 to maintain the vehicle 16 in the restrained position 18 (step 408). The rear surface 190 of the rear impact guard 50 can also be described as a vehicle-forward surface 110 of the rear impact guard 50.

As discussed above, this movement of the barricade member 24 into the blocking position 28 can be preceded by movement of the barricade member 24 through the verification process. In this verification process, the barricade member 24 can be used to assess the exact position of the rear impact guard 50. The verification process can also be used to verify that the rear impact guard 50 is in a position within which the barricade member 24 will engage the rear impact guard 50. During the verification process, if the barricade member 24 does not directly engage the rear impact guard 50, the method 400 can restart, or certain individual steps of the method 400 can be performed again to reassess or redetermine the location of the rear impact guard 50 with respect to at least one of the vehicle restraining mechanism 10 and the wall 44 of the loading dock 12.

Referring again to FIGS. 1-16, the method 400 can include a step 410 that includes operating the linear actuator 32 to move the restraint assembly 22, with the barricade member 24 locked in the blocking position 28, toward the rear impact guard 50 to apply a predetermined restraining force 54 or pressure against the rear impact guard 50. As discussed above, in certain aspects of the device, one or more of the sensors 42 for the restraining mechanism 10 can be used to recognize when the appropriate restraining force 54 or pressure is applied and instructs the linear actuator 32 to maintain the restraint assembly 22 in the desired linear position 40. The application of this predetermined restraining force 54 or pressure is indicative of the restrained position 18 of the vehicle 16.

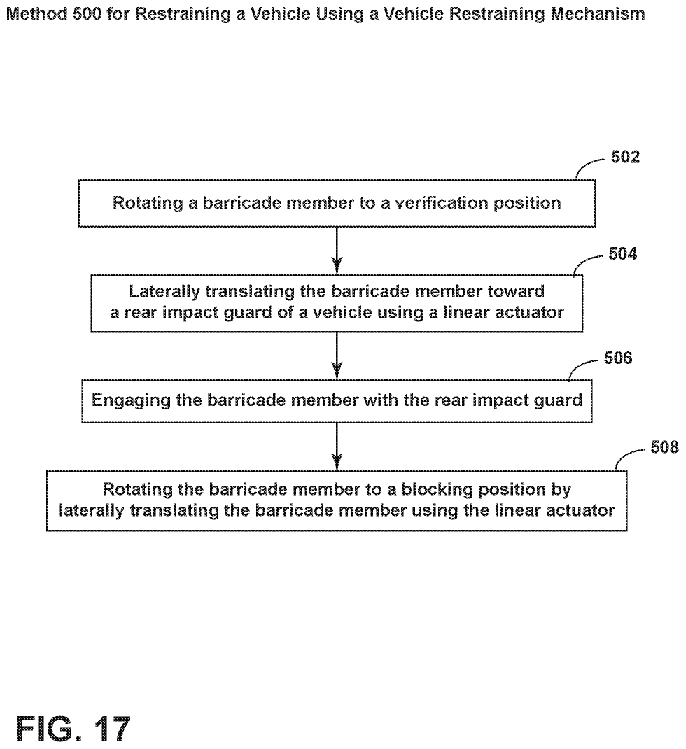

Referring now to FIGS. 1-15 and 17, having described various aspects of the vehicle restraining mechanism 10, a method 500 is disclosed for restraining a vehicle 16 relative to a loading dock system utilizing various aspects of the vehicle restraining mechanism 10. According to the method 500, the blocking member 24 is rotated to the verification position 30 (step 502). The blocking member 24 and the remainder of the restraining assembly 22 is operated via the linear actuator 32 in the direction of a rear impact guard 50 of a vehicle 16 (step 504). The blocking member 24 in verification position 30 is then engaged with the rear impact guard 50 of vehicle 16 (step 506). Linear actuator 32 is then operated further to bias the blocking member 24 against the rear impact guard 50 (step 508). This operation of linear actuator 32 rotates the blocking member 24 against the rear impact guard 50 and, in turn, rotates the blocking member 24 into the blocking position 28. As discussed herein, a locking mechanism 112 is engaged to prevent rotation of the blocking member 24 beyond the blocking position 28. This locking member 112 can be activated any time after the blocking member 24 rotates toward the verification position 30 and passes the blocking position 28. In this manner, as the linear actuator 32 operates to move the blocking member 24 toward the rear impact guard 50, a locking member 112 is typically engaged during this entire movement of the restraint assembly 22. In certain aspects of the device, the locking mechanism 112 will be engaged when the blocking member 24 reaches the verification position 30. The locking mechanism 112 can also be engaged when the blocking member 24 reaches the contact position 58, where the blocking member 24 engages the rear impact guard 50. Various other configurations are contemplated such that the locking mechanism 112 is engaged before the blocking member 24 is rotated from the verification position 30 and back into the blocking position 28 through operation of the linear actuator 32.

According to various aspects of the device, the vehicle restraining mechanism 10 can be used in connection with various types of loading dock mechanisms. Such mechanisms can include, but are not limited to, dock levelers, lip plates, elevating docks, hydraulically-operated levelers, manually operated levelers, automatic levelers, combinations thereof and other similar loading dock mechanisms.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle restraining mechanism for a loading dock system, the vehicle restraining mechanism comprising:
a restraint assembly having a barricade member that is rotationally operable between a stored position, a blocking position and a verification position, wherein the barricade member in the blocking position selectively secures a vehicle relative to a wall of a loading dock;
a linear actuator that laterally operates the barricade member along a linear path of travel that is generally perpendicular to a rotational axis of the barricade member; and
a sensor in communication with at least one of the linear actuator and the barricade member, wherein the sensor and the linear actuator cooperate to position the barricade member in relation to a rear impact guard of the vehicle that is parked at the loading dock.

2. The vehicle restraining mechanism of claim 1, wherein the sensor is coupled with the restraint assembly and monitors a rotational position of the barricade member with respect to the rear impact guard, during operation of the linear actuator.

3. The vehicle restraining mechanism of claim 1, wherein the barricade member in the blocking position is generally perpendicular to the linear actuator.

4. The vehicle restraining mechanism of claim 1, wherein the blocking position is between the verification position and the stored position, and wherein the barricade member is maintained in the verification position by force of gravity, and wherein the barricade member is operated from the verification position to the blocking position via selective operation of the linear actuator toward the loading dock.

5. The vehicle restraining mechanism of claim 1, further comprising:
a track system that fixedly secures the linear actuator to a substrate, wherein the track system includes at least one guide member that guides the restraint assembly between a plurality of linear positions that includes a retracted position and a plurality of extended positions, wherein the blocking position is further defined by an extended position of the plurality of extended positions.

6. The vehicle restraining mechanism of claim 5, wherein the linear actuator includes an articulating member that is linearly operable to define the retracted position and the plurality of extended positions, and wherein the articulating member is attached to the restraint assembly at a pivot joint that is oriented generally parallel with the rotational axis of the barricade member.

7. The vehicle restraining mechanism of claim 5, wherein the at least one guide member includes outer guide rails that engage an outer flange of the restraint assembly.

8. The vehicle restraining mechanism of claim 2, wherein the barricade member is biased against the rear impact guard via operation of the linear actuator to define the blocking position of the barricade member.

9. The vehicle restraining mechanism of claim 6, wherein the barricade member is operated by a hydraulic cylinder and at least partially operated by the linear actuator.

10. The vehicle restraining mechanism of claim 1, wherein the blocking position is defined by the barricade member being held in place by a mechanical lock and further defined by the linear actuator biasing the barricade member against the rear impact guard.

11. The vehicle restraining mechanism of claim 10, wherein operation of the linear actuator determines a restraining force that is exerted upon the rear impact guard.

12. A vehicle restraining mechanism for a loading dock system, the vehicle restraining mechanism comprising:
a restraint assembly having a barricade member that is rotationally operable at least between a blocking position and a verification position, wherein the barricade member in the blocking position selectively secures a vehicle relative to a loading dock; and
a linear actuator that laterally operates the barricade member along a linear path of travel that is generally perpendicular to a rotational axis of the barricade member; wherein
the linear actuator selectively translates the barricade member in the verification position to contact a rear impact guard of the vehicle to define a contact position;
further operation of the linear actuator beyond the contact position biases the barricade member against the rear impact guard and rotates the rear impact guard from the verification position to the blocking position; and
the restraint assembly includes an operable lock that selectively maintains the barricade member in the blocking position.

13. The vehicle restraining mechanism of claim 12, further comprising:
a sensor coupled to the barricade member that monitors a rotational position of the barricade member between the verification position and the blocking position during operation of the linear actuator beyond the contact position.

14. The vehicle restraining mechanism of claim 12, wherein the operable lock includes a mechanical lock that mechanically secures the barricade member in the blocking position.

15. The vehicle restraining mechanism of claim 12, further comprising:
a track system that fixedly secures the linear actuator to a substrate, wherein the track system includes at least one guide member that guides the restraint assembly between a plurality of positions that includes a retracted position and a plurality of extended positions, wherein the blocking position is further defined by an extended position of the plurality of extended positions.

16. The vehicle restraining mechanism of claim 15, wherein the linear actuator includes an articulating member that is linearly operable to define the retracted position and the plurality of extended positions, and wherein the articulating member is attached to the restraint assembly at a pivot joint that is oriented generally parallel with the rotational axis of the barricade member.

17. The vehicle restraining mechanism of claim 15, wherein the at least one guide member includes outer guide rails that engage an outer flange of the restraint assembly.

18. A method for restraining a vehicle relative to a loading dock system:
parking the vehicle at a loading dock;
placing a barricade member of a restraint assembly in a verification position;
laterally translating the restraint assembly from a retracted position to an extended position relative to the vehicle;
engaging the barricade member in the verification position with a portion of the vehicle; and
rotating the barricade member to a blocking position by further laterally translating the restraint assembly to engage a rear surface of a rear impact guard of the vehicle.

19. The method of claim 18, wherein the blocking position is defined by a generally vertical orientation of the barricade member.

20. The method of claim 18, wherein the barricade member is rotated from the verification position to the blocking position via operation of a linear actuator that laterally translates the restraint assembly.
